(19) United States
(12) Patent Application Publication
(10) Pub. No.: US 2014/0029996 A1
(43) Pub. Date: Jan. 30, 2014

(54) SHEET CLAMPING AND CONVEYING UNIT AND IMAGE FORMING APPARATUS WITH SAME

(71) Applicant: Kenji NOZAWA, Kanagawa (JP)

(72) Inventor: Kenji NOZAWA, Kanagawa (JP)

(73) Assignee: RICOH COMPANY, LTD., Tokyo (JP)

(21) Appl. No.: 13/937,324

(22) Filed: Jul. 9, 2013

(30) Foreign Application Priority Data
Jul. 26, 2012 (JP) 2012-166232
Feb. 1, 2013 (JP) 2013-018432

(51) Int. Cl. G03G 15/00

(52) U.S. Cl. CPC G03G 21/203
USPC 399/388

(57) ABSTRACT

A sheet clamping and conveying unit is installed in an image forming apparatus together with an image forming unit that prints a toner image onto a recording sheet and an fixing unit that heats and fixes the toner image printed by the image forming unit onto the recording sheet. The sheet clamping and conveying unit includes a first rotary member having a surface made of metallic material, a second rotary member pressing against the first rotary member, and a heating unit to heat one of the first and the second rotary members. The sheet clamping and conveying unit conveys the recording sheet toward the image forming unit by continuously rotating the first and second rotary members while clamping and pressing and pressing the recording sheet in a contact area caused between the first and second rotary members.

### CROSS-REFERENCE TO RELATED APPLICATIONS

This patent application is based on and claims priority pursuant to 35 U.S.C. §119 to Japanese Patent Application Nos. 2012-166232 and 2013-18432, filed on Jul. 26, 2012 and Feb. 1, 2013, respectively, in the Japan Patent Office, the entire disclosures of which are hereby incorporated by reference herein.

### BACKGROUND

1. Technical Field

This invention relates to a sheet clamping and conveying unit having two metal rotary members that collectively clamp and feed a recording sheet fed therebetween onward to an image forming unit included in an image forming apparatus and an image forming apparatus with the sheet clamping and conveying unit.

2. Related Art

A recording sheet bearing an image formed in an image forming apparatus sometimes has a burr, which is a rise typically generated at an edge of a sheet when a bunch of original sheets is cut into multiple sheets having a prescribed size by a cutting blade in an approaching direction of the cutting blade. When the recording sheet with such a burr is used in the image forming apparatus, a contacting target tightly contacted by a toner image in the image forming apparatus is scratched by the burr and ultimately disturbs and degrades the toner image.

For this reason, Japanese Patent Application Publication No. JP-2011-121702-A, for example, discloses a clamping device for an image forming apparatus in which that a recording sheet is clamped between an intermediate transfer belt as a contacting target and a secondary transfer roller, and a toner image is transferred from the intermediate transfer belt onto the recording sheet. The recording sheet is subsequently clamped again by a pressure roller and a fixing belt as a contacting target between the pressure roller and the fixing belt to fix the toner image onto the recording sheet. Further disclosed in JP-2011-121702-A is that the intermediate transfer belt and the fixing belt are accordingly scratched by the burr generated in the recording sheet, and a defective image appears due to such scratches in such an exemplary configuration.

As a countermeasure against such a problem, the image formation apparatus disclosed in of JP-2011-121702-A has a sheet clamping and conveying unit that is capable of clamping and conveying the recording sheet before sending the recording sheet to a secondary transfer nip to minimize the possibility of occurrence of such a defective image.

Specifically, in the image formation apparatus of JP-2011-121702-A, the sheet clamping and conveying unit reduces a height of the burr even generated in the recording sheet by pressing the burr of the recording sheet against first and second rotating metal rollers with each other in an contact area between the first and second rotating metal rollers when clamping and delivering the recording sheet toward the secondary transfer nip. Hence, by minimizing such the possibility of scratching the fixing and intermediate transfer belts, by pressing the burr of the recording sheet against these fixing and intermediate transfer belts, occurrence of such a disturbed and defective toner image due to the scratches of these belts can be likely similarly minimized.

It is also known that when a recording sheet having poor breathability, such as a coated sheet, etc., is employed to execute printing in the image forming apparatus, the toner image is highly likely disturbed, because a toner blister is sometimes generated in the fixing unit. That is, although there exist few escape routes in a fiber of the recording sheet having such poor breathability for water vapor generated when the recording sheet is heated to escape from the recording sheet to an outside of the recording sheet, these escape routes are almost blocked by a toner image adhered to a surface of the recording sheet. For this reason, the water vapor in the fiber of the recording sheet does not smoothly evacuate from an inside of the recording sheet to the outside thereof quickly, thereby increasing atmospheric pressure in the fiber of the recording sheet. As a result, when the atmospheric pressure is increased to some extent, the water vapor penetrates the toner image at once and forms fine holes and/or generates blisters in the toner image, specifically, the surface of the recording sheet. Such holes or blisters are collectively referred to as the toner blisters, and they disturb the toner image as a problem.

For this reason, Japanese Patent Application Publication No. JP-2005-96948-A discloses an image forming apparatus enabled to minimize the possibility of occurrence of such toner blisters by providing a dehumidifier to dehumidify a recording sheet before forming a toner image on the recording sheet in order to suppress occurrence of wrinkles in the recording sheet possibly caused due to rapid water evaporation from the recording sheet in the fixing unit of the image forming apparatus.

More specifically, the dehumidifier dehumidifies the recording sheet by pressing the recording sheet against a heated film member that heats the recording sheet to encourage the water evaporation from the recording sheet. Accordingly, by dehumidifying the recording sheet with the dehumidifier before conveying the recording sheet to the fixing unit, a generation amount of the water vapor in the recording sheet during a fixing process can be likely reduced while minimizing the occurrence of the toner blister accordingly. Hence, to upgrade image quality, the disturbance of the toner image caused by both of the scratches in the contacting targets due to the burr and the toner blister in the recording sheet are preferably minimized by providing both the above-described dehumidifier and the sheet clamping and conveying unit.

However, employment of these sheet clamping and conveying unit and the dehumidifier ends up upsizing the image forming apparatus as a problem.

### SUMMARY

Accordingly, the present invention provides a novel sheet clamping and conveying unit to be installed in an image forming apparatus together with an image forming unit to print a toner image onto a recording sheet and a fixing unit to heat and fix the toner image printed by the image forming unit onto the recording sheet. The sheet clamping and conveying unit is disposed upstream of the image forming unit and the fixing unit. The sheet clamping and conveying unit includes a housing housed in the image forming apparatus, a first rotary member having a surface made of metal supported by the housing, a second rotary member supported by the housing to press against the first rotary member while forming a contact area between the first and second rotary members, and a heating unit to heat one of the first and the second rotary members. The sheet clamping and conveying unit conveys a recording sheet toward the image forming unit by clamping, pressing, and heating the recording sheet in the contact area while continuously rotating the first and second rotary members.

In another aspect of the present invention, an image forming apparatus includes an image forming unit to print a toner image onto a recording sheet, a fixing unit to heat and fix the toner image printed by the image forming unit onto the recording sheet, and a sheet clamping and conveying unit disposed upstream of the image forming unit and the fixing unit to convey the recording sheet to the image forming unit. The sheet clamping and conveying unit includes a housing housed in the image forming apparatus, a first rotary member having a surface made of metal supported by the housing, a second rotary member supported by the housing to press against the first rotary member while forming a contact area between the first and second rotary members, and a heating unit to heat one of the first and the second rotary members. The sheet clamping and conveying unit conveys a recording sheet toward the image forming unit by clamping, pressing, and heating the recording sheet in the contact area while continuously rotating the first and second rotary members.

### BRIEF DESCRIPTION OF THE DRAWINGS

A more complete appreciation of the present invention and many of the attendant advantages thereof will be more readily obtained as substantially the same becomes better understood by reference to the following detailed description when considered in connection with the accompanying drawings, wherein:

FIG. 1 is a schematic diagram illustrating an exemplary printer according to one embodiment of the present invention;

FIG. 2 is an expanded view illustrating an exemplary sheet clamping and conveying unit provided in the printer according to one embodiment of the present invention;

FIG. 3 is an enlarged view typically and schematically illustrating a burr generated at an edge of a recording sheet P in a related art related to one embodiment of the present invention;

FIG. 4 is a graph illustrating an exemplary relation between moisture content of the recording sheet P obtained after a dehumidifying process and surface temperature (i.e., temperature for heating the recording sheet P) of a first metal roller generated in the dehumidifying process according to one embodiment of the present invention; and

FIG. 5 is a graph illustrating an exemplary relation between the moisture content of the recording sheet P and a rank of a toner blister produced in the recording sheet P according to one embodiment of the present invention.

### DETAILED DESCRIPTION

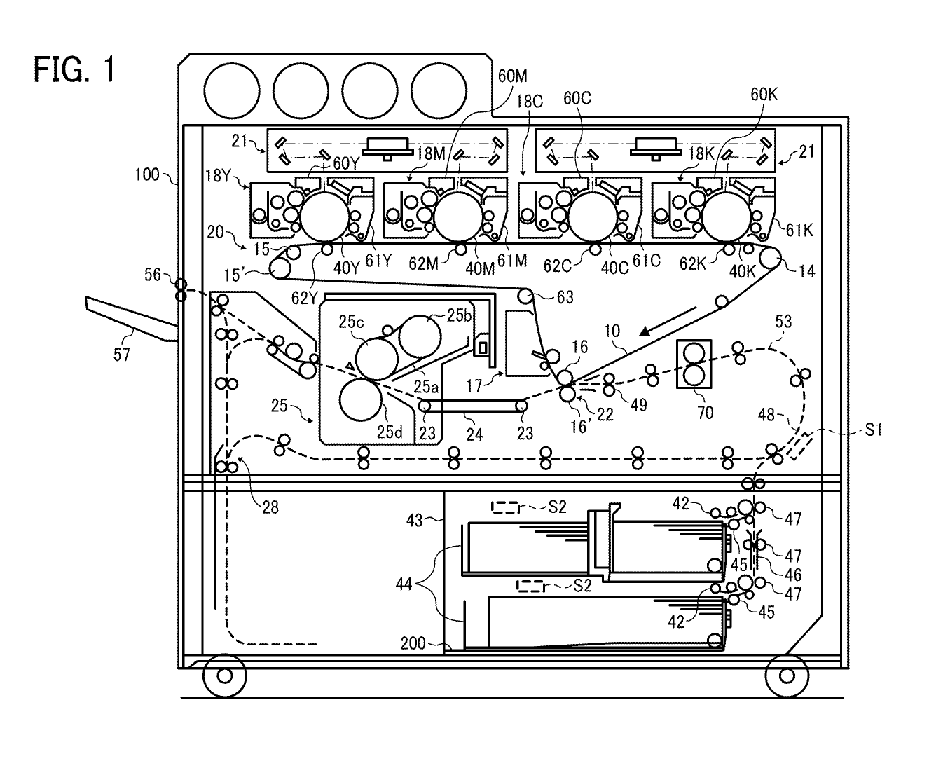

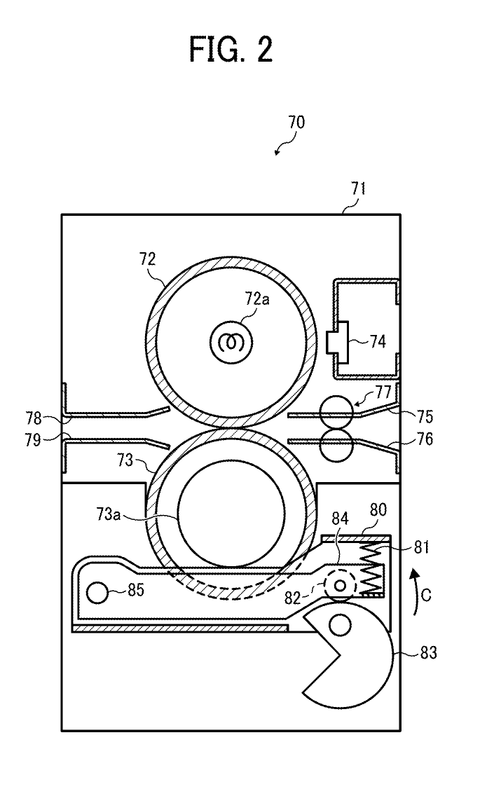

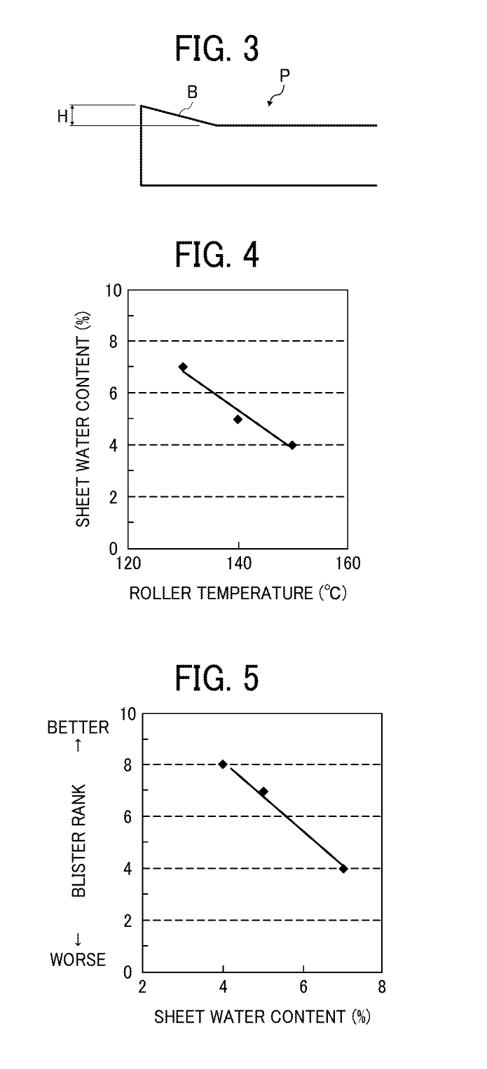

Referring now to the drawings, wherein like reference numerals designate identical or corresponding member throughout the several views thereof and in particular to FIG. 1, an electro-photographic printer as an image forming apparatus to which a first embodiment of the present invention is applied is described herein below. As shown there, a printing unit 100 has a feeding unit (i.e., a sheet feeding table) to accommodate and supply recording sheets P toward a sheet-feeding path. The printing unit 100 also has a printing unit mounted on the feeding unit. Subscripts Y (Yellow), M (Magenta), C (Cyan), and K (Black) placed next to respective reference signs in the drawing indicate members employed for yellow, cyan, magenta, and black colors. Near a center of the printing unit, an endless intermediate transfer belt 10 is provided as an intermediate transfer member and is stretched by multiple supporting rollers 14, 15, 15′, 16, and 63 to be rotated and conveyed clockwise. Among the entire intermediate transfer belt 10 in a circumferential direction of the intermediate transfer belt 10, a cleaning unit 17 just engages with a front side of a winding portion winding around a cleaning backup roller. The cleaning unit 17 removes residual toner remaining on the intermediate transfer belt 10 after an image transfer process. A region between the support rollers 14 and 15 among the entire intermediate transfer belt 10 in a circumferential direction nearly extends horizontally. Further, a tandem type image-forming unit 20 is provided above the region between the support rollers 14 and 15. In the tandem image forming unit 20, four of yellow, magenta, cyan, and black toner image forming devices 18Y, 18M, 18C, and 18K are disposed along the intermediate transfer belt 10 facing to a front surface of the intermediate transfer belt 10 the intermediate transfer belt 10. Above the tandem image forming unit 20, there is provided a pair of optical writing units (an exposing unit) 21 as an optical writing device. In the toner image forming devices 18Y, 18M, 18C, and 18K of the tandem image forming unit 20, multiple drum type photoconductors 40Y, 40M, 40C, and 40K are provided as latent image bearers to form latent images of yellow, magenta, cyan, and black colors, respectively. Surfaces of the photoconductors 40Y, 40M, 40C, and 40K are charged uniformly by multiple charging units 60Y, 60M, 60C, and 60K, and subsequently subjected to optical scanning processes of the optical device (i.e., the exposure unit) 21 that drives a light source in accordance with image data, respectively. With the optical scanning, electrostatic latent images are formed on the surfaces of the photoconductors 40Y, 40M, 40C, and 40K, respectively. The electrostatic latent images formed on the surfaces of the photoconductors 40Y, 40M, 40C, and 40K are subsequently developed by multiple developing devices 61Y, 61M, 61C, and 61K, respectively. With this, Y, M, C, and K toner images are formed as visualized images on the surfaces of the photoconductors 40Y, 40M, 40C, and 40K, respectively. Below the photoconductors 40Y, 40M, 40C, and 40K, multiple primary transfer rollers 62Y, 62M, 62C, and 62K are provided to press the intermediate transfer belt 10 against the photoreceptors 40Y, 40M, 40C, and 40K, respectively. With this, multiple primary transferring nips are formed for Y, M, C, and K colors on tangents in which the photoconductors 40Y, 40M, 40C, and 40K and the intermediate transfer belt 10 engage with each other. Around the primary transfer nips for Y, M, C, and K colors, multiple primary transfer electric fields are formed between the primary transfer rollers 62Y, 62M, 62C, and 62K to which primary transferring biases are applied and electrostatic latent images borne on the photoreceptors 40Y, 40M, 40C, and 40K, respectively. Upon receiving the image data, the printing unit 100 rotates the supporting roller 14 using a driving unit, not shown, and continuously moves the intermediate transfer belt 10 clockwise in the drawing. At the same time, the printing unit 100 drives the toner image forming devices 18Y, 18M, 18C, and 18K to form toner images of Y, M, C, and K colors on the photoconductors 40Y, 40M, 40C, and 40K, respectively. These toner images are subsequently primarily transferred and superimposed on the front surface of the intermediate transfer belt 10 at the primary transferring nips for the Y, M, C, and K colors, respectively. Hence, a four-color superimposed toner image is formed on the front surface of the intermediate transfer belt 10. Further, when a black monochromatic image is formed on the intermediate transfer belt 10, the following operation can be executed. Specifically, the yellow, magenta and cyan photoconductors 40Y, 40M, and 40C are moved to separate from the intermediate transfer belt 10 by moving the support rollers 15 and 15′ other than the supporting roller 14 serving as the driving roller. The printing unit 100 also selectively rotates one of sheet feeding rollers 42 provided on a sheet-feeding table 200 in the sheet-feeding unit. Thus, the printing unit 100 feeds the recording sheet P from one of sheet feeding cassettes 44 provided in multiple steps provided in a sheet bank 43. After separating and sending the recording sheets P one by one with a separating roller 45 to the sheet-feeding path 46, a conveying roller 47 further conveys the recording sheet P to the sheet-feeding path 48 provided in the printing unit. The recording sheet P entering the sheet-feeding path 48 of the printing unit passes through the sheet clamping and conveying unit 70 and is thereby dehumidified. The recording sheet P subsequently bumps against a registration nip formed between a pair of registration rollers 49 and stops there. Below the intermediate transfer belt 10, a secondary transferring system 22 is provided. Specifically, a secondary transfer roller 16′ is engaged with the intermediate transfer belt 10 at a winding point winding around a secondary transfer opposed roller 16 among the entire intermediate transfer belt 10 in its circumferential direction to form a secondary transfer nip in the secondary transferring system 22. The pair of registration rollers 49 starts driving and sends the recording sheet P toward the secondary transfer nip synchronizing with a four-color superimposed toner image borne on the intermediate transfer belt there to transfer the four-color superimposed toner image onto the recording sheet P in the second transfer nip. Specifically, in the transfer nip, with both a secondary transfer electric field and nip pressure, the four-color superimposed toner image on the intermediate transfer belt 10 is secondarily transferred onto the recording sheet P. The recording sheet P passing through the secondary transfer nip is subsequently sent to the fixing unit 25. The fixing unit 25 has a fixing belt unit and a pressure roller 25d. The fixing belt unit includes a heating roller 25b, a fixing roller 25c, and a fixing belt 25a wound, stretched, and thereby continuously moved by these rollers 25b and 25c. Further, in the fixing belt unit, a fixing nip is formed by engaging the fixing belt 25a with the pressing roller 25d. The endless fixing belt 25a has a multilayer structure including a substrate layer made of prescribed material, such as nickel, stainless steel, polyimide, etc., and an elastic layer mainly composed of silicone rubber or the like laminated on a front side of the substrate layer. The heating roller 25b disposed inside a loop of the fixing belt 25a has a hollow roller mainly composed of prescribed metal, such as iron, aluminum, etc., and a heat source, such as a halogen heater, etc., inside the hollow roller. The fixing belt 25a is continuously moved clockwise in the drawing as the fixing roller 25c is driven and rotates while being stretched by the heating roller 25b and the fixing roller 25c provided inside the loop of the fixing belt 25a. Thus, the heating roller 25b heats the fixing belt 25a during such an endless moving process. At a winding portion of the fixing belt 25a among the entire fixing belt 25a in a circumferential direction, which is opposed to the fixing roller 25c, a pressing roller 25d engages with the fixing belt 25a from a front surface of the fixing belt 25a and forms a fixing nip on the fixing belt 25a. Thus, the four-color superimposed toner image is fixed onto the surface of the recording sheet P sent to the fixing unit 25 when the recording sheet P traverses the fixing nip and is pressed and heated. The recording sheet P passing through the fixing unit 25 is stacked on a sheet ejection tray 57 after it is discharged outside a machine (i.e., the image forming apparatus) via the pair of sheet ejecting rollers 56. When a double-sided printing mode is executed to form images on both sides of the recording sheet P, the recording sheet P with the toner image fixed only onto one side of the recording sheet P is sent to a sheet retransmission unit 28 instead of the pair of sheet ejecting rollers 56 after passing through the fixing unit 25. Then, the recording sheet P is retransmitted to the sheet-feeding path 48 while the sheet retransmission unit 28 inverts its front and backsides. Further, the recording sheet P is sent to the secondary transfer nip from the sheet-feeding path 48 and a four-color superimposed toner image is secondarily transferred additionally onto the second side of the recording sheet P. The recording sheet P is subsequently ejected outside the machine via the fixing unit 25 and the pair of sheet ejecting rollers 56. A belt-cleaning unit 17 removes transfer residual toner passing through the secondary transfer nip and adhering to the surface of the intermediate transfer belt 10. The intermediate transfer belt 10 subsequently enters the primary transferring nips for Y, M, C, and K colors once again. FIG. 2 is an enlarged view illustrating an exemplary construction of the sheet clamping and conveying unit 70. The sheet clamping and conveying unit 70 includes a housing 71, a first metal roller 72, a second metal roller 73, a surface temperature sensor 74, and an upper entrance guide plate 75, a lower entrance guide plate 76, a pair of auxiliary conveying rollers 77, an exit upper guide plate 78, an exit lower guide plate 79, and an outer arm 80 or the like. Further, a coil spring 81, a bumping roller 82, an eccentric cam 83, an inner arm 84, and an operation swinging shaft 85 or the like are also provided in the sheet clamping and conveying unit 70. The upper and lower entrance guide plates 75 and 76 are vertically aligned to face each other via a gap to accept a recording sheet P sent from the secondary transfer nip and guide the recording sheet P toward inside the housing 71. The pair of auxiliary conveying rollers 77 is thus disposed beside these upper and lower entrance guide plates 75 and 76. The pair of auxiliary conveying rollers 77 includes a first auxiliary conveying roller driven and rotated by a motor, not shown, and a second auxiliary conveying roller driven and rotated by the first auxiliary conveying roller engaging and forming an auxiliary conveyance nip between the first and second auxiliary conveying rollers. The first auxiliary conveying roller is disposed right under the second auxiliary conveying roller. The first auxiliary conveying roller has a driving force introduction gear, not shown in the drawing, fixed to its rotary shaft and receives rotational driving force by meshing the driving force introduction gear with a driving force transmission gear, also not shown in the drawing, secured to a rotary shaft of the first metal roller 72. The recording sheet P accepted in the housing 71 is clamped between the pair of auxiliary conveying rollers 77 and is conveyed from entrance to exit sides of the sheet clamping and conveying unit 70. Accordingly, the first metal roller 72 and the second metal roller 73 disposed just below the first metal roller 72 are positioned on the left side of the pair of auxiliary conveying rollers 77 in the drawing. The second metal roller 73 is enabled to engage and disengage with the pair of auxiliary conveying rollers 77 under control of an engaging and disengaging mechanism as described later in detail. Specifically, when the second metal roller 73 is pressed against the first metal roller 72 by the engaging and disengaging mechanism, the second metal roller 73 engages with the first metal roller 72 and forms a metal contact area between the first metal roller 72 and the second metal roller 73. When the metal contact area is thus formed and the first metal roller 72 is driven and rotated by a driving unit, not shown in the drawing, the second metal roller 73 is also driven and rotated. FIG. 3 is an enlarged view schematically illustrating the vicinity of an edge of the recording sheet P. The recording sheet P sometimes includes burr B when an original sheet is cut as shown in the drawing. When such a burr B damages either an elastic surface layer of the intermediate transfer belt 10 in the secondary transfer nip or that of the fixing belt 25a in the fixing nip thereby generating scratches, unevenness appears in a toner image tracing those scratches thereby disturbing the toner image. When such disturbance severely grows, not only ruggedness appears but also some of the images disappear. Then, as shown in FIG. 2, when the metal contact area is already formed, the recording sheet P discharged from the auxiliary conveyance nip is clamped in the metal contact area and is conveyed from the entrance side toward the exit side of the sheet clamping and conveying unit 70. At this moment, since it is intensively squeezed by the first and the second metal rollers 72 and 73 between the first and the second metal rollers 72 and 73, a height H of the burr B existing at the edge is reduced. Hence, in this printer, after such a burr reduction process is applied to the recording sheet P by the sheet clamping and conveying unit 70 before the recording sheet P is sent to the secondary transfer nip, the recording sheet P is conveyed through the secondary transfer nip and the fixing nip in this order. Hence, disturbance of the toner image caused by the scratches on the intermediate transfer belt 10 or the fixing belt 25a as a contacting target created by the burr B of the recording sheet P can be likely minimized. Here, if the second metal roller 73 is spaced from the first metal roller 72 so that the metal contact area is not formed, the recording sheet P can be likely conveyed from the entrance side to the exit side by rotation driving force of the pair of auxiliary conveying rollers 77. In any case, the recording sheet P passing through the metal contact area approaches a gap between exit upper and lower guide plates 78 and 79 vertically opposed to each other and is guided to the outside of the sheet clamping and conveying unit 70. A rotary shaft of the first metal roller 72 is rotatably supported by a bearing, not shown, installed in the housing 71. By contrast, a rotary shaft of the second metal roller 73 is rotatably supported by a bearing 73a installed in the housing 71. Further, the bearing 73a is supported by an outer arm 80 disposed below the bearing 73a. The engaging and disengaging mechanism that brings the second metal roller 73 to engage and disengage with the first metal roller 72 includes an outer arm 80, a coil spring 81, a bumping (engaging) roller 82, an eccentric cam 83, an inner arm 84, and an operation swinging shaft 85. The outer arm 80 and the inner arm 84 are aligned side by side in a rotary shaft direction of the second metal roller 73. More specifically, the inner arm 84 is disposed closer to a widthwise center of the first metal roller 72 in the rotary shaft direction than the outer arm 80. Specifically, the inner arm 84 is located on a backside more than the outer arm 80 in the direction perpendicular the drawing. Further, one end (hereinafter referred to as a free end of a lever) of each of those two inner and outer arms 84 and 80 in its longitudinal direction is enabled to move in orbit around the operation swinging shaft 85 that penetrates the other end of each of those two inner and outer arms 84 and 80. The free end of the inner arm 84 is situated below the free end of the outer arm 80, and these two free ends are connected by the coil spring 81. Further, the free end of the inner arm 84 rotatably supports the bumping roller 82. The eccentric cam 83 is driven and rotated around a rotary shaft and is disposed blow the free end of the inner arm 84 with its cam side contacting the bumping roller 82 of the inner arm 84. Thus, when the free end of the inner arm 84 is pushed up through the bumping roller 82 as the eccentric cam 83 rotates, the free end of the outer arm 80 is accordingly pushed up to the free end of the inner arm 84 through the coil spring 81. Consequently, the bearing 73a supported by the outer arm 80 is accordingly pushed up so that the second metal roller 73 is pressed against the first metal roller 72. Meanwhile, when a smaller radius portion of the eccentric cam 83 comes to contact the bumping roller 82 as it rotates, a boosting length of the free end of the inner arm 84 caused by the eccentric cam 83 decreases. Consequently, a boosting length of the free end of the outer arm 80 boosted by the free end of the inner arm 84 also decreases, and the bearing 73a supported by the outer arm 80 moves away from the first metal roller 72. Hence, the second metal roller 73 separates from the first metal roller 72. In this way, the engaging and disengaging mechanism of the sheet clamping and conveying unit 70 is able to engage and disengage the second metal roller 73 with the first metal roller 72. Now, an exemplary characteristic configuration of the printer according to one embodiment of the present invention is described with reference to applicable drawings. Specifically, the first metal roller 72 has a hollow roller structure made of metal containing a halogen lamp 72a as a heating unit. The surface temperature sensor 74 is disposed on the right side of the first metal roller 72 in the drawing. This surface temperature sensor 74 detects surface temperature of the first metal roller 72 and sends a detection result as a digital signal to a control unit, not shown. When the detection result of a surface temperature sent from the surface temperature sensor 74 is lower than a given target heating temperature, the control unit serving as a control unit increases the surface temperature of the first metal roller 72 by supplying power to the halogen lamp 72a. By contrast, when the detection result of a surface temperature sent from the surface temperature sensor 74 is higher than the given target heating temperature, the control unit as a controller decreases the surface temperature of the first metal roller 72 by stopping power supplying to the halogen lamp 72a. With this, the surface temperature of the first metal roller 72, specifically, heating temperature for heating the recording sheet P with the sheet clamping and conveying unit 70 can be likely almost maintained at the given heating temperature target value. Further, in addition to the burr height reduction process using its pressure, the sheet clamping and conveying unit 70 applies a dehumidification process to the recording sheet P clamped in the metal contact area between first and second metal rollers 72 and 73 to encourage evaporation of water from inside the recording sheet P by heating the recording sheet P with the first metal roller 72. In other words, the sheet clamping and conveying unit 70 functions as a dehumidifier to dehumidify the recording sheet P by heating it before sending the recording sheet P to the image forming unit including the a secondary transfer nip or the like. Thus, the printer can be likely efficiently suppressed to upsize when compared with that in which the dehumidifier is separately employed from the sheet clamping and conveying unit 70 while minimizing disturbance of the toner image caused by both the scratches of the intermediate transfer belt 10 and the fixing belt 25a and the toner blister as well. The engaging and disengaging mechanism of the sheet clamping and conveying unit 70 not only simply engages and disengages the second metal roller 73 with the first metal roller 72, but also functions to adjust pressure in the contact area when the second metal roller 73 is engaged with the first metal roller 72. In particular, the engaging and disengaging mechanism of the sheet clamping and conveying unit 70 increases the pressure of the contact area by rotating the eccentric cam 83 to further push up the free end of the inner arm 84 when these two metal rollers 72 and 73 are engaged with each other. Specifically, the engaging and disengaging mechanism functions as a pressure adjusting unit that adjusts the pressure of the second metal roller 73 pressing against the first metal roller 72. In such configuration, however, when a thick recording sheet P is used and enters such a metal contact area, excessive rising of pressure in the metal contact area can be likely avoided by weakening the pressure than that normally applied to the metal contact area, so that unnecessary rising of a torque of a driving source driving the first metal roller 72 can be likely minimized.

Heretofore, the various embodiments of the present invention relate to the printer that forms the toner image using the electro-photographic technology. However, the present invention is not limited thereto and can be also applied to an image forming apparatus that employs a toner projection system to form a toner image as well. Specifically, the toner projection system is a system that prints a toner image on either a recording sheet P or an intermediate recording member by letting a toner-flying device to generate and cause a dot state toner group to fly and adhere to either the recording sheet P or the intermediate record member. As the image forming apparatus employing the toner projection system, an image forming apparatus described in Japanese Patent Application Publication No. JP-2002-307737-A is known as one example. Also described heretofore is the example, in which the halogen lamp 72a heats the first metal roller 72 as a heating unit. However, a heating unit may is also provided to heat the second metal roller 73. Hence, an image forming unit is configured by the intermediate transfer belt 10 and each of the transferring rollers to print a toner image onto the recording sheet P in this printer.

Now, various exemplary printers that employ a more unique configuration according to several embodiments of the present invention are described with reference to applicable drawings. Herein after, a configuration of each of the various printers is similar to each other unless otherwise particularly described therein.

A first embodiment of the present invention is now initially described.

In general, a recording sheet P rarely causes a toner blister even when it includes a great amount of water in it if the recording sheet P has satisfactory breathability. That is, in such a satisfactory breathable recording sheet P, since there are many escape routes for air to evacuate from an inside of the recording sheet P to a surface of the recording sheet P, water vapor can highly likely dissipate from the surface of the recording sheet P not covered by the toner even if many toner particles adhere to the surface of the recording sheet P. Thus, the sheet clamping and conveying unit 70 is to be controlled to decreasingly dehumidify the recording sheet P when it is satisfactory breathable. Accordingly, despite that if the recording sheet P including much water is heated at high temperature to evaporate the water like the recording sheet P having poor breathability is heated, wasted energy is unavoidably consumed. For this reason, in the printer of the first embodiment, heating temperature of the sheet clamping and a conveying unit 70 is different between when an uncoated sheet P with relatively satisfactory breathability is heated and when a coated sheet P with relatively poor breathability is heated. For this reason, the printer of the first embodiment includes an operation display unit, not shown, composed of a ten-key pad and a touch screen or the like. Thus, the operator can input sheet type information indicating that a recording sheet P set to the sheet feeding tray of the sheet feeding table 200 is either an uncoated sheet P or a coated sheet P through the operation display unit. In other words, in the printer of the first embodiment, the operation display unit functions as a sheet type information acquiring device that acquires sheet type information of a recording sheet P before sending the recoding sheet P to the sheet clamping and conveying unit 70. Specifically, the control unit sets a lower heating temperature target value when the uncoated sheet P is used than when the coated is used so that the sheet clamping and a conveying unit 70 heats the recording sheet P at such lower temperature. Hence, wasteful consumption of energy caused by excessively heating the uncoated recording sheet P in the sheet clamping and conveying unit 70 can be likely avoided.

A second embodiment of the present invention is now described with reference to applicable drawings.

When a recording sheet P is excessively dehumidified by the sheet clamping and a conveying unit 70, a transferring process executed in the secondary transfer nip is sometimes degraded thereby deteriorating its quality. In particular, since a sufficient secondary transfer current can no longer flow between the recording sheet P and the secondary transfer roller when it is excessively dehumidified only to include a low moisture content in the secondary transfer nip, the transferring process becomes defective. Therefore, a prescribed desirable amount of water can be likely left in the recording sheet P even after the sheet clamping and conveying unit 70 dehumidifies the recording sheet P. FIG. 4 is an exemplary graph illustrating a prescribed relation between a moisture content of a recording sheet P after it is dehumidified by the sheet clamping and conveying unit 70 and surface temperature (i.e., heating temperature for heating a recording sheet P) of the first metal roller 72 used in the dehumidification operation. This graph is obtained based on an experiment in which a recording sheet P containing a prescribed amount of water is dehumidified in various temperature levels. In the experiment, Magnostar™ 130 gsm sheet is used as a recording sheet P. As shown in the drawing, the higher the heating temperature (i.e., surface temperature of the first metal roller 72), the less the moisture content of the recording sheet P after the dehumidifying process. That is, the higher the heating temperature, the more the water evaporation from an inside the recording sheet P. In the drawing, moisture content is about five percent after the dehumidification in an exemplary situation when Magnostar having 130 gsm is used as the recording sheet P and is heated at a heating temperature of approximately 140 degrees centigrade. Thus, when a recording sheet P thicker than the Magnostar of 130 gsm sheet is used, moisture content becomes more than about five percent after it is heated at approximately 140 degrees centigrade. That is, if the moisture content before the dehumidification is the same, the thicker recording sheet P contains an amount of water more than the thinner one does. FIG. 5 is a graph that illustrates a prescribed relation between moisture content of a recording sheet P and a rank of toner blister. This chart is obtained based on an experiment, in which multiple images are formed on recording sheets P with various moisture contents while observing disturbance of the images caused by the toner blister. In the experiment, the Magnostar of 130 gsm sheet is used as the recording sheet P again. As understood from the drawing, the lower the moisture content of the recording sheet P, the less the disturbance in the image due to the toner blisters. That is, the lower the moisture content of the recording sheet P, the less amount the water vapor generated inside the recording sheet P in the fixing nip. Further, when attention is paid only to the toner blister, i.e., only the toner blister is concerned, it is preferable that the moisture content of the recording sheet P is as lower as possible after the dehumidification of the recording sheet P. However, when the moisture content is too low, a transferring process is unavoidably defective in the secondary transfer nip as described above. Thus, it is desirable to maintain a moderate amount of water in the recording sheet P after the dehumidification of the recording sheet P. However, heating temperature varies in accordance with a thickness of the recording sheet P to maintain the moderate amount of water therein. For this reason, in the printer of the second embodiment, heating temperature of the sheet clamping and conveying unit 70 is controlled to vary in accordance with the thickness of the recording sheet P. Specifically, the printer (of the second embodiment) again includes the operation display unit, not shown, having the ten-key pad and the touch screen or the like. Thus, the operator can input thickness information of the recording sheet P through the operation display unit. In other words, in the printer of the second embodiment, the operation display unit functions as a thickness information acquiring device that acquires thickness information of the recording sheet P before sending the recoding sheet P to the sheet clamping and conveying unit 70. Further, the control unit sets a higher heating temperature target value as the thickness of the recording sheet P increases, so that the sheet clamping and conveying unit 70 heats the recording sheet P at higher temperature. Hence, the recording sheet P can appropriately obtain a prescribed amount of the moisture content regardless of its thickness even after receiving the dehumidification in the sheet clamping and conveying unit 70. Here, as a thickness detector, a sheet thickness information acquisition device that actually detects a sheet thickness in accordance with a moving amount of prescribed rollers when the recording sheet P is clamped in a nip formed between the prescribed rollers.

A third embodiment of the present invention is now described with reference to applicable drawings.

There exists a correlation between moisture content of the recording sheet P and humidity in a machine. The higher the humidity, the more the moisture content contained in the recording sheet P. Further, to keep the moisture content constant in the recording sheet P after dehumidification of the recording sheet P, heating temperature is increased in the sheet clamping and conveying unit 70 to evaporate more amount of moisture content from inside the recording sheet P as the moisture content of the recording sheet P increases before dehumidification. For this reason, the printer of the third embodiment has a humidity sensor as an environmental detector that detects humidity in the machine using a well-known technology. Further, the control unit increases the above-described heating temperature target value as the humidity detected by the humidity sensor increases. In such an exemplary configuration, moisture content of the recording sheet P after the dehumidification of the recording sheet P can be likely constant regardless of the humidity in the machine. Furthermore, in lieu of the humidity sensor, a temperature sensor may be used as an environmental sensing unit. That is, a correlation can be likely almost established between the temperature and the humidity.

A fourth embodiment of the present invention is now described with reference to applicable drawings.

A printer according to the fourth embodiment includes a moisture content detector, not shown, at a position S1 as shown in FIG. 1 to detect moisture content of a recording sheet P. Specifically, the moisture content detector sends a digital signal to the above-described control unit a detection result when detecting the moisture content of the recording sheet P. As the moisture content detector, a sensor sensing humidity of something conveyed in the vicinity the sensor, such as a micro heating system, etc., as described in Japanese Patent Application Publication JP-07-055748-A is known. The control unit corrects a heating temperature target value as a control objective, i.e., a surface temperature of the first metal roller 72, in accordance with a detection result of the quantity of moisture content coming from the moisture content detector. Specifically, the heating temperature target value is corrected to increase as the quantity of moisture content as the detection result increases. With this, the recording sheet P is increasingly heated in the sheet clamping and conveying unit 70 with higher temperature as the moisture content therein increases.

By contrast, the recording sheet P is decreasingly heated in the sheet clamping and conveying unit 70 with lower temperature as the moisture content therein decreases. Thus, shortly after the recording sheet P is passed from the sheet-feeding path 46 of the sheet-feeding table 200 to the sheet-feeding path 48 of the printing unit 100, the moisture content detector 89 detects its moisture content. Subsequently, the heating temperature target value is corrected in accordance with the result of detection in the above-described manner, and after that the recording sheet P enters the sheet clamping and conveying unit 70. In this printer, the moisture content detector is disposed pretty far upstream of the sheet clamping and conveying unit 70 in the entire sheet feeding path 48. For this reason, there is some time lag from when the heating temperature target value is corrected in accordance with the result of moisture content detection of the recording sheet P to when the recording sheet P enters the sheet clamping and conveying unit 70. Thus, the surface temperature of the first metal roller 72 can be likely changed close to the heating temperature target value during this time lag. As the location to cause such a time lag, a position opposed to the recording sheet P just before entering the sheet-feeding path 48 can be exemplified beside the position S1 located in the vicinity of the entrance of the sheet-feeding path 48. Specifically, with such an exemplary configuration, since the sheet clamping and conveying unit 70 appropriately heats the recording sheet P at a prescribed heating temperature in accordance with the moisture content of the recording sheet P, the moisture content of the recording sheet P after the dehumidification of the recording sheet P can be likely appropriately brought to a prescribed level as described below regardless of the moisture content of the recording sheet before the dehumidification of the recording sheet P. Specifically, the moisture content is appropriate if it has a level capable of effectively minimizing the toner blister in the fixing unit 25 while effectively providing a secondary transfer current to the recording sheet in the secondary transfer nip. By thus appropriately controlling the moisture content of the recording sheet to such a level even after dehumidification of the recording sheet P, defective transference can be likely suppressed while minimizing the occurrence of the toner blister. Further, the moisture content detector can be disposed upstream of the sheet clamping and conveying unit 70 at an immediate place of the sheet clamping and conveying unit 70. In this situation, the conveying unit of the recording sheet P is suspended before the sheet clamping and conveying unit 70 and the surface temperature of the first metal roller 72 is corrected and changed to a level close to the heating temperature target value, and the conveying unit of the recording sheet P is resumed thereafter. When there exists a very small quantity of moisture content of the recording sheet P before dehumidification, the dehumidification of the sheet clamping and conveying unit 70 is not to be executed too much. In such a situation, even if the heating temperature target value of the first metal roller 72 is corrected to be the same to a room temperature level for example, it takes a certain time period for the first metal roller 72 to decrease its surface temperature down to the room temperature. For this reason, the control unit sends the recording sheet P to the sheet clamping and conveying unit 70 without waiting until the surface temperature of the first metal roller 72 decreases down to the room temperature when determining that the sheet clamping and conveying unit 70 does not dehumidify the recording sheet P. However, before the control unit sends the recording sheet P to the sheet clamping and conveying unit 70, the second metal roller 73 is separated from the first metal roller 72 by operating the engaging and disengaging mechanism. With this, the recording sheet P can be likely passed through the sheet clamping and conveying unit 70 without being heated by the first metal roller 72 at a temperature not decreased down to the room temperature. Here, when the recording sheet P is shorter than a distance between of a pair of upstream conveyor rollers disposed upstream and a pair of downstream conveyor rollers disposed downstream of these two metal rollers (72 and 73), the recording sheet P is not passed between the pair of upstream conveyor rollers disposed upstream to the pair of downstream conveyor rollers disposed downstream via the two metal rollers (72 and 73). For this reason, when such a short recording sheet P is used, the below described control may be executed. Specifically, at a time when the end of the recording sheet P enters a gap between the pair of metal rollers (72 and 73), the pair of metal rollers is approximated to each other for the first time to simply clamp the end of the recording sheet P between the pair of metal rollers (72 and 73) and pass the recording sheet P to the pair of downstream conveyor rollers disposed downstream by utilizing carrying force of these pair of metal rollers (72 and 73). In a duplex printing mode, the moisture content detector detects a moisture content of a recording sheet P again right after the recording sheet P is retransmitted to the vicinity of the entrance of the sheet-feeding path 48 from the fixing unit 25 by the sheet retransmission unit 28. The retransmitted recording sheet P often decreases its moisture content due to passing through the fixing unit 25. For this reason, the moisture content detector detects the thus decreased moisture content, and the heating temperature target value used by the sheet clamping and conveying unit 70 is corrected in accordance with the detection result. Subsequently, a prescribed amount of secondary transfer current is appropriately provided to the recording sheet P in the secondary transfer nip to maintain prescribed moisture content of the recording sheet P capable of effectively minimizing the toner blister in the fixing unit 25. With this, the moisture content of the recording sheet P is maintained even when the image formation is executed onto a second side in the double-sided printing mode. Further, a four-color superimposed toner image is formed and borne on the first side of the recording sheet P when it is fed again from the fixing unit 25 by the sheet retransmission unit 28 in the sheet-feeding path 48 of the printing unit 100. Accordingly, when the recording sheet P is retransmitted to a position opposed to the moisture content detector and the four color superimposed toner image intervene between the surface of the recording sheet P and the moisture content detector, detection result of the moisture content by the moisture content detector generates a large error. In short, the moisture content detection result greatly diminishes than an actual value as a result. For this reason, the moisture content detector is disposed at a position in the printer as indicated by a reference sign S1 in FIG. 1 to detect the moisture content of one side of the recording sheet P among both sides of the recording sheet P, on which a toner image is after that recorded by the image forming unit composed of an intermediate transfer belt 10 or the like. With such an exemplary configuration, the second side among the first and second sides of the recording sheet P retransmitted through the sheet-feeding path 48 in the duplex mode is opposed to the moisture content detector before a four-color superposed toner image is transferred onto the second side of the recording sheet P. Thus, by avoiding a situation, in which the four-color superimposed toner image is present between the surface of the recording sheet P in the retransmission process and the moisture content detector, detection error of the moisture content occurring due to intervening of the toner image can be likely avoided. Further, as indicated by a reference sign S2 in FIG. 1, the moisture content detector can be disposed in the sheet-feeding tray 200 to detect the moisture content of the recording sheet P stored therein. With such an exemplary configuration, by detecting the moisture content of the stopping recording sheet with the moisture content detector, inaccurate detection of the moisture content, which is typically caused by a variation of a distance between the moisture content detector and the surface of the recording sheet P due to flapping of the recording sheet P caused during its conveying unit, can be likely avoided.

A fifth embodiment of the present invention is now described with reference to applicable drawings.

In a recording sheet P, there is a good correlation between breathability and air permeability. A measurement method using a Gurley type air permeability meter is generally employed to measure air permeability. This is a method of measuring a time (i.e., a Gurley second) taken by a gas having a prescribed volume to permeate through a paper sheet. In the method, as breathability of the paper sheet becomes increasingly deteriorates, the air permeability increasingly grows, because the gas permeation takes a longer time period. For this reason, in the fifth embodiment of the printer, an operation display unit including a numeric ten-keypad key or a touch screen and the like is provided so that an operator can input air permeability of the recording sheet P accommodated in the sheet feeding tray 200 into the operation display unit. In other words, in the printer of the fifth embodiment, the operation display unit functions as an air permeability information acquiring device that acquires air permeability information of the recording sheet P before sending the recording sheet P to the sheet clamping and conveying unit 70. The control unit determines the heating temperature target value in accordance with the air permeability inputted through the control display unit. Specifically, as the air permeability (i.e., the Gurley second) increases, the heating temperature target value is determined as being greater. Hence, wasteful energy consumption due to excessive heating an excellently breathable sheet P in the sheet clamping and conveying unit 70 at high-temperature can be likely minimized.

A sixth embodiment of the present invention is now described with reference to applicable drawings.

In general, the toner blister rarely occurs in a recording sheet P when a small number of toner particles sticks to a surface of the recording sheet P even if the recording sheet P contains much water and accordingly has a relatively poor breathability. That is, since the escape routes for air are rarely blocked if there exist small numbers of toner particles on the recording sheet P, water vapor generated inside the recording sheet P can leave the recording sheet P to an outside of the recording sheet P avoiding the toner particles borne on the recording sheet. For this reason, according to the sixth embodiment, the printer calculates an amount of toner born on the recording sheet P in accordance with image information and changes heating temperature of the sheet clamping and conveying unit 70 in accordance with the calculation result. Specifically, a smaller amount of toner adheres onto a recording sheet P per unit area in a monochrome mode, in which only K toner is used, than in a full-color mode, in which four-color toner particles are used. Then, the control unit differentiates heating temperature in between the monochrome and full-color modes in accordance with the amount of toner borne on the recording sheet P. More specifically, when the monochrome mode is designated as an operating mode, the control unit choses 50[° degrees centigrade as a target value heating temperature regardless of moisture content of the recording sheet P. Hence, wasteful energy consumption, which is possibly caused by the sheet clamping and conveying unit 70 by excessively heating the recording sheet P at high temperature in the monochrome mode, in which the toner blister rarely occurs, can be likely avoided. By contrast, when the operation mode is a full-color mode or a mixed-mode including full-color and monochrome modes, the control unit changes and increases the heating temperature target value as the moisture content detected by the moisture content detector increases. With this, the sheet clamping and conveying unit 70 heats the recording sheet P at higher temperature to increasingly evaporate the water as the moisture content of the recording sheet P increases, so that the moisture content of the recording sheet P can appropriately have a prescribed value capable of effectively minimizing the toner blister and defective transference after dehumidification of the recording sheet P.

A seventh embodiment of the present invention is now described with reference to applicable drawings.

In the seventh embodiment, the printer employs a constant heating temperature target value. In other words, the above-described correction process to correct the heating temperature target value in accordance with the sheet type or the moisture content is omitted here. Therefore, instead of the second metal roller 73 shown in FIG. 2, a clamping elastic roller made of rubber or the like is installed. Specifically, when the clamping elastic roller is pressed against the first metal roller 72, a surface of the clamping elastic roller elastically deforms, so that the first metal roller 72 can invade the clamping elastic roller. This invasion forms a clamping nip having a prescribed width (i.e., a contact width) in a surface moving direction of the first metal roller 72 and the clamping elastic roller, in which the first metal roller 72 and the clamping elastic roller engage with each other. The width of the clamping nip varies in accordance with pressure of the clamping elastic roller pressing against the first metal roller 72 (i.e., a rotation stopping position of the eccentric cam 83). Thus, in this exemplary printer, the outer arm 80, the coil spring 81, the bumping roller 82, the eccentric cam 83, the inner arm 84, and the operation swinging shaft 85 or the like collectively serve as the contact width-changing device for changing the nip width as the contact width. Further, similar to the printer of the first embodiment, the printer of the seventh embodiment can accept inputting of sheet type information indicating either a recording sheet P set to the sheet feeding tray 200 is an uncoated sheet or a coated sheet as well. In other words, the operation display unit serves as a sheet type information-acquiring device that acquires the sheet type information of the recording sheet P before sending the recording sheet P to the sheet clamping and conveying unit 70. The control unit controls the clamping elastic roller to more intensively press against the first metal roller 72 with stronger pressure via the eccentric cam 83 when the coated sheet P is used than when the uncoated sheet P is used to widen the nip between. Hence, the heating time for heating the recording sheet P in the clamping nip is elongated further more to increasingly provide calorie to the recording sheet P. With such an exemplary configuration, the recording sheet P is appropriately heated with a prescribed calorific value in accordance with the breathability of the recording sheet P without changing the heating temperature of the first metal roller 72, so that the occurrence of toner blister and defective transference as well can be likely minimized.

An eighth embodiment of the present invention is now described with reference to applicable drawings.

Similar to the printer of the seventh embodiment, the printer of the eighth embodiment of the present invention is equipped with the clamping elastic roller instead of the second metal roller 73. Further, the outer arm 80 or the like is also provided to serve as a contact width-changing device 80. As mentioned in above-described embodiment, to keep the moisture content of the recording sheet P after the dehumidification of the recording sheet P, heating temperature is to be increased in the sheet clamping and conveying unit 70 in order to evaporate more amount of water from inside the recording sheet P as moisture content of the recording sheet P before dehumidification increases. For this reason, a humidity sensor employing a well-known technology is provided in this embodiment as an environmental detector to detect humidity in a machine (i.e., the printer) of the eighth embodiment. Then, as humidity detected by the humidity sensor increases, the clamping elastic roller is pressed against the first metal roller 72 with stronger force to widen the clamping nip between the clamping elastic roller and the first metal roller 72. With this, as the detection result of the humidity increases, greater calorie is ultimately provided to the recording sheet P in the clamping nip. Accordingly, with such an exemplary configuration, the moisture content of the recording sheet P after the dehumidification of the recording sheet P can be likely constant regardless of the humidity environment. Here, in lieu of the humidity sensor, a temperature sensor may be used as the environmental sensing unit.

A ninth embodiment of the present invention is now described with reference to applicable drawings.

Similar to the printer of the seventh embodiment, the printer of the ninth embodiment of the present invention is equipped with the clamping elastic roller instead of the second metal roller 73. Also provided is the outer arm 80 or the like to serve as the contact width-changing device 80 again. Similar to the printer of the fourth embodiment, the printer of the ninth embodiment of the present invention is equipped with the moisture content detector, not shown, to detect moisture content of the recording sheet P at a position S1 as shown in FIG. 1. Hence, the control unit changes pressure of the clamping elastic roller pressing against the first metal roller 72 in accordance with the information of moisture content sent from the moisture content detector to adjust a width of the clamping nip. Specifically, the control unit rotates the eccentric cam 83 to a position to cause stronger pressure to more maximize the nip width as the detection of the moisture content increases. With this, as the moisture content increases, greater calorie is increasingly supplied to the recording sheet P indeed in the sheet clamping and conveying unit 70. By contrast, however, as the moisture content decreases indeed, less heat is decreasingly provided to the recording sheet P in the sheet clamping and conveying unit 70. With such an exemplary configuration, the recording sheet P is heated with a satisfactory calorific value in accordance with the moisture content without changing the heating temperature of the first metal roller 72, so that occurrence of the toner blister and the defective transference can be likely minimized as well.

A tenth embodiment of the present invention is now described with reference to applicable drawings.

Even when a recording sheet P includes much water, it rarely causes the toner blister if the recording sheet P has satisfactory breathability. That is, since there are many escape routes for air to evacuate from inside a sheet P to a surface of the recording sheet P, water vapor can highly likely dissipate onto the surface of the recording sheet P not covered by the toner even if many toner particles adhere to the surface of the recording sheet P having satisfactory breathability. Thus, when a satisfactory breathable sheet P is used, necessity of dehumidifying the recording sheet P by the sheet clamping and conveying unit 70 decreases. Despite that, when the recording sheet P including lots of water is heated at high temperature to evaporate the water as a recording sheet P with poor breathability is heated, energy is excessively consumed. For this reason, a printer of the tenth embodiment of the present invention is configured to include both of the printers of the eighth and ninth embodiments. Further, a width of the clamping nip is changed in accordance with a situation if an uncoated sheet P relatively having a satisfactory breathability is used or a coated sheet P relatively having a poor breathability is used. Specifically, this printer of the tenth embodiment of the present invention is controlled to meet a prescribed relation between a moisture content detected by the moisture content detector, a sheet type, and a width of a clamping nip as described below in the first table.

First Table

Nip Width

| | | |
|---|---|---|
| Sheet Type | Uncoated Sheet | Coated Sheet |

| | | | |
|---|---|---|---|
| Moisture | X ≦ 2 | 20 mm | 27 mm |
| Content X | 2 < X ≦ 4 | 22 mm | 29 mm |
| (g/m³) | 4 < X ≦ 6 | 24 mm | 31 mm |
| | 6 < X ≦ 8 | 26 mm | 33 mm |
| | 8 < X | 28 mm | 35 mm |

Specifically, as shown in the first table, as the moisture content of the recording sheet P increases, a width of the clamping nip increases. When the moisture content is the same, the nip width is greater when the coated sheet P is used than when the uncoated sheet P is used. Although the nip width is described in the first table for the sake of convenience, a rotary angle position of the eccentric cam 83 is practically used as a control parameter instead of the nip width when the nip width is changed. Therefore, an encoder, not shown, is provided to detect the rotation angular position of the eccentric cam 83 in this printer. Further, a data table listing rotation angular positions corresponding to the nip widths is stored instead of the nip widths of the first table in an information storage device (for example, a ROM and a Flash memory or the like) of the control unit. The control unit identifies a rotational angular position of the eccentric cam 83 in accordance with a combination of sheet type information inputted through the control display unit and moisture content detected by the moisture content detector with reference to the data table. Further, the control unit calculates a difference between (a specified rotational angular position,) a rotary angular position of a current status and the rotation angular position thus identified with reference to the data table, and further calculates a driving amount of a cam motor capable of eliminating the difference. Subsequently, the nip width is adjusted to have a prescribed size in accordance with the above-described combination by driving the cam motor by the driving amount obtained in accordance with the calculation result while rotating the eccentric cam 83 up to the thus identified rotation angular position. With such an exemplary configuration, since the recording sheet P is appropriately heated with a prescribed calorific value in accordance with the sheet type and the moisture content of the recording sheet P as well in the clamping nip without changing the heating temperature, the moisture content of the recording sheet P can be likely preferably adjusted even after the dehumidification of the recording sheet P, so that occurrence of the toner blister and the defective transference as well can be likely effectively minimized.

An eleventh embodiment of the present invention is now described with reference to applicable drawings.

Similar to the printer of the seventh embodiment, the printer of the eleventh embodiment of the present invention is equipped with the clamping elastic roller instead of the second metal roller 73. The outer arm 80 or the like is also provided to serve as the contact width-changing device 80. Similar to the printer of the fifth embodiment, the operation display unit functions as an air permeability information-acquiring device that acquires air permeability information of the recording sheet P before sending the recoding sheet P to the sheet clamping and conveying unit 70. Further, the control unit determines a width of the clamping nip in accordance with an air permeability inputted through the operation display unit. Specifically, as the air permeability (i.e., Gurley seconds) increases, the clamping nip width is correspondingly increased. Hence, the blister possibly caused when the recording sheet P having an excellent breathability is excessively heated at high temperature in the sheet clamping and conveying unit 70 can be likely avoided without changing the heating temperature of the first metal roller 72.

A twelfth embodiment of the present invention is now described with reference to applicable drawings.

A printer of the twelfth embodiment of the present invention is configured including both of the printers of the eighth and eleventh embodiments. Specifically, this printer of the twelfth embodiment of the present invention is controlled to establish a prescribed relation between moisture content detected by the moisture content detector and air permeability information as an acquiring result as shown in the below described second table.

Second Table

| | | Nip Width | | |
|---|---|---|---|---|
| Air Permeability Y | | Y < 2000 | 2000 ≦ Y ≦ 20000 | 20000 < Y |
| (Gurley Seconds) | | | | |
| Moisture | X ≦ 2 | 23 mm | 25 mm | 27 mm |
| Content X | 2 < X ≦ 4 | 25 mm | 27 mm | 29 mm |
| (g/m³) | 4 < X ≦ 6 | 27 mm | 29 mm | 31 mm |
| | 6 < X ≦ 8 | 29 mm | 31 mm | 33 mm |
| | 8 < X | 31 mm | 33 mm | 35 mm |

As shown in the second table, as the moisture content of the recording sheet P increases, a width of the clamping nip is increased. Further, when the moisture content is the same, the nip width is greater as the air permeability degree increases. Although the nip width values are described in the second table for the sake of convenience, a rotational angular position of the eccentric cam 83 is practically used as a control parameter instead of the nip width when the nip width is changed. Therefore, a rotary encoder, not shown, is provided to detect the rotational angular position of the eccentric cam 83 in this printer of the twelfth embodiment. Further, a data table listing rotational angular positions corresponding to the nip widths is stored in an information storage device (for example, a ROM (Read Only Memory) and a Flash memory or the like) of the control unit in this embodiment instead of the nip width value of the second table. Hence, the control unit identifies a rotational angular position of the eccentric cam 83 with reference to the data table in accordance with a combination of air permeability information inputted into the control display unit and the moisture content detected by the moisture content detector. Further, the control unit calculates a difference between a rotary angular position of a current status and the rotation angular position thus identified with reference to the second data table, and further calculates a driving amount of a cam motor capable of eliminating the difference between the rotary angular position of a current status and the thus identified rotation angular position. Subsequently, the nip width is adjusted to have a prescribed size in accordance with the above-described combination by driving the cam motor by an amount obtained in accordance with the calculation result while rotating the eccentric cam 83 up to the thus identified rotational angular position. With such an exemplary configuration, since the recording sheet P is appropriately heated with a prescribed calorific value in accordance with the air permeability and the moisture content of the recording sheet P as well in the clamping nip without changing the heating temperature, the moisture content of the recording sheet P can be likely appropriately adjusted even after the dehumidification of the recording sheet P. Thus, occurrence of the toner blister and the defective transference as well can be likely effectively minimized.

A thirteenth embodiment of the present invention is now described with reference to applicable drawings.

When a small number of toner particles stick to a recording sheet P, toner blister rarely occurs therein even if the recording sheet P contains much water and thus relatively has poor breathable performance. That is, since the small number of toner particles rarely blocks the escape routes for air, water vapor generated inside the recording sheet P can come to leave the recording sheet P to the outside while avoiding the toner borne on the recording sheet. For this reason, in the printer of the thirteenth embodiment, it is equipped with the clamping elastic roller instead of the second metal roller 73. The outer arm 80 or the like is also provided to serve as the contact width-changing unit 80 similar to the printer of the seventh embodiment. Specifically, in the printer of the thirteenth embodiment, an amount of toner on the recording sheet P is calculated in accordance with image information and adjusts a width of the clamping nip in accordance with the calculation result. Specifically, in the monochrome mode only using K-toner (i.e., black toner), an amount of toner adhering to a sheet P per unit area decreases when it is compared with that in a full-color mode that uses four-color toner particles. Then, the control unit accordingly differentiates the nip width in between the monochrome, full-color, and mixed modes. To describe more in detail, the nip width in the monochrome mode is changed to be smaller than that in the full-color mode or the mixed mode. Thus, the recording sheet P can be likely appropriately heated by the first metal roller 72 with a prescribed amount of calorie in accordance with the toner amount without changing the heating temperature of the first metal roller 72.

A fourteenth embodiment of the present invention is now described with reference to applicable drawings.

The printer of the fourteenth embodiment of the present invention is configured by including the printers of eighth and twelfth embodiments. This printer of the fourteenth embodiment of the present invention is controlled to meet a prescribed relation between moisture content detected by the moisture content detector and operation modes of image formation executed therein as shown in the below described third table.

| | | THIRD TABLE | | |
|---|---|---|---|---|
| | | Nip Width | | |
| Mode | | Monochrome | Full-Color | Dual Mode |
| | | Mode | Mode | (Monochrome/ |
| | | | | Full-Color Mode) |
| Moisture | X ≦ 2 | 23 mm | 27 mm | 27 mm |
| Content X | 2 < X ≦ 4 | 25 mm | 29 mm | 29 mm |
| (g/m³) | 4 < X ≦ 6 | 27 mm | 31 mm | 31 mm |
| | 6 < X ≦ 8 | 29 mm | 33 mm | 33 mm |
| | 8 < X | 33 mm | 35 mm | 35 mm |

As shown in the table 3, as the moisture content of the recording sheet P increases, a width of the clamping nip is correspondingly increased. Further, when the moisture content is the same, the nip width is greater in the full-color mode and mixed mode than that in the monochrome mode. Although the nip widths are listed in the table 3 for the sake of convenience, a rotation angular position of the eccentric cam 83 is practically used as a control parameter instead of the nip width when the nip width is changed. For this reason, a rotary encoder, not shown, is provided to detect the rotation angular position of the eccentric cam 83 in this printer of the fourteenth embodiment. Further, a data table listing rotation angular positions corresponding to the nip widths is stored in an information storage device (for example, a ROM and a Flash memory or the like) of the control unit in this printer of the fourteenth embodiment instead of the nip width of table 3. The control unit identifies a rotational angular position of the eccentric cam 83 in accordance with a combination of the operation mode and the moisture content detected by the moisture content detector with reference to the data table. Further, the control unit calculates a difference between a rotary angular position of a current status and the rotation angular position thus identified with reference to the data table, and further calculates a driving volume of a cam motor capable of eliminating the difference between the rotary angular position of a current status and the thus identified rotation angular position. Subsequently, the nip width is adjusted to have a prescribed size in accordance with the above-described combination by driving the cam motor by an amount obtained in accordance with the calculation result while rotating the eccentric cam 83 up to the thus identified rotation angular position. With such an exemplary configuration, since the recording sheet P is appropriately heated with a prescribed calorific value in accordance with an amount of toner borne on the recording sheet P and the moisture content of the recording sheet P as well in a clamping nip without changing the heating temperature of the first metal roller 72, the moisture content of the recording sheet P can be likely appropriately adjusted even after the dehumidification of the recording sheet P. As a result, occurrence of the toner blister and the defective transference as well can be likely effectively minimized.

The above-described embodiments are just examples of the resent invention and various modifications and variations can possible as well. Hence, the present invention may provide the below described advantages with unique characteristics per embodiment.

For example, according to one aspect of the present invention, an exemplary sheet clamping and conveying unit (for example, a sheet clamping and conveying unit 70 or the like) is installed in an image forming apparatus together with an image forming unit (for example, a combination of a pair of optical writing units 21, a tandem type image forming unit 20, and various multiple transfer rollers or the like) to print a toner image onto a recording sheet P, and a fixing device (for example, a fixing unit 25 or the like) to heat and fix the toner image formed by the image forming unit onto the recording sheet P. The exemplary sheet clamping and conveying unit is characterized by including a housing housed in the image forming apparatus, a first rotary member having a surface made of metal supported by the housing, and a second rotary member supported by the housing to press against the first rotary member while forming a contact area between the first and second rotary members. A heating unit is provided to heat one of the first and the second rotary members. The exemplary sheet clamping and conveying unit conveys a recording sheet toward the image forming unit by clamping, pressing, and heating the recording sheet in the contact area while continuously rotating the first and second rotary members. With such an exemplary configuration, the sheet clamping and conveying unit can be likely compact.

According to another aspect of the present invention, the exemplary sheet clamping and conveying unit is characterized by further including a pressure adjusting unit operatively connected to one of the first and second rotary members to adjust pressure on the one of the first and second rotary members from the other one of the first and second rotary members. With such an exemplary configuration, unnecessary increasing in torque caused when pressure is excessively applied to the recording sheet P in the metal contact area can be likely minimized as described in one embodiment of the present invention.

According to yet another aspect of the present invention, the exemplary sheet clamping and conveying unit is characterized by further including a halogen heater as the heating unit. With such an exemplary configuration, the sheet clamping and conveying unit can function as the dehumidifier provided with a commercially available halogen heater in the sheet clamping and conveying unit.

Further, according to another aspect of the present invention, an exemplary image forming apparatus is characterized by including an image forming unit to print a toner image onto a recording sheet, a fixing unit to heat and fix the toner image printed by the image forming unit onto the recording sheet, and a conveying unit disposed upstream of the image forming unit to convey the recording sheet to the image forming unit. The sheet clamping and conveying unit includes a housing housed in the image forming apparatus, a first rotary member having a surface made of metal supported by the housing, a second rotary member supported by the housing to press against the first rotary member while forming an contact area between the first and second rotary members, and a heating unit to heat one of the first and the second rotary members. The sheet clamping and conveying unit conveys a recording sheet toward the image forming unit by clamping, pressing, and heating the recording sheet in the contact area while continuously rotating the first and second rotary members. With such an exemplary configuration, the exemplary image forming apparatus can be likely downsized.

According to yet another aspect of the present invention, the exemplary image forming apparatus is characterized by including a sheet type information acquiring device (for example, an operation display unit or the like) to acquire sheet type information of the recording sheet P before the recording sheet P is sent to the sheet clamping and conveying unit and a control unit (for example, a control section or the like) to control heating temperature of the heating unit in accordance with the sheet type information acquired by the sheet type information acquiring device. With such an exemplary configuration, by heating and dehumidifying the recording sheet P at a prescribed heating temperature suitable for a sheet type, moisture content of the recording sheet P can be likely preferably adjusted within a prescribed level capable of effectively avoiding occurrence of toner blister and defective transference regardless of the recording sheet type after the dehumidification of the recording sheet P as described, for example, in the first embodiment.

According to yet another aspect of the present invention, the exemplary image forming apparatus is characterized by including a sheet thickness information acquiring device to acquire sheet thickness information of the recording sheet P before the recording sheet P is sent to the sheet clamping and conveying unit and a control unit to control heating temperature of the heating unit in accordance with thickness information of the recording sheet acquired by the sheet thickness information acquiring device. With such an exemplary configuration, by heating and dehumidifying the recording sheet P at a heating temperature suitable for a sheet thickness, moisture content of the recording sheet P can be likely preferably adjusted within a prescribed level capable of effectively avoiding occurrence of toner blister and defective transference as well regardless of the thickness of the recording sheet P after the dehumidification of the recording sheet P as described, for example, in the second embodiment.

According to yet another aspect of the present invention, the exemplary image forming apparatus is characterized by including an environment condition detector to detect one of natural conditions of surroundings of the image forming apparatus and a control unit to control heating temperature of the heating unit in accordance with the one of natural conditions of surroundings of the image forming apparatus detected by the environment condition detector. With such an exemplary configuration, by heating and dehumidifying the recording sheet P with heating temperature suitable for humidity in the machine, moisture content of the recording sheet P can be likely preferably adjusted within a prescribed level capable of effectively avoiding occurrence of toner blister and defective transference as well regardless of the humidity in the machine after the dehumidification of the recording sheet P as described, for example, in the third embodiment.

According to yet another aspect of the present invention, the exemplary image forming apparatus is characterized by including a moisture content detector (for example, a moisture content sensor or the like) to detect moisture content of a recording sheet P before the recording sheet P is sent to the sheet clamping and conveying unit, and a control unit (for example, a controller or the like) to control heating temperature of the heating unit in accordance with the moisture content detected by the moisture content detector. With such an exemplary configuration, moisture content of the recording sheet P can be likely preferably adjusted within a prescribed level capable of effectively avoiding occurrence of toner blister and defective transference as well regardless of the humidity in the machine after the dehumidification of the recording sheet P as described, for example, in the fourth embodiment.

According to yet another aspect of the present invention, the exemplary image forming apparatus is characterized by including an air permeability information acquiring device (for example, an operation display unit or the like) to acquire air permeability information of the recording sheet P before the recording sheet P is sent to the sheet clamping and conveying unit and a control unit to control heating temperature of the heating unit in accordance with the air permeability information acquired by the air permeability information acquiring device. With such an exemplary configuration, toner blister and defective transference as well caused due to excessive heating of the recording sheet P even having excellent breathability at a high temperature in the sheet clamping and conveying unit can be likely avoided as described, for example, in the fifth embodiment.

According to yet another aspect of the present invention, the exemplary image forming apparatus is characterized by including an image information acquiring device to acquire image information to be printed by the image forming unit onto the recording sheet as a toner image in accordance with the image information, before the recording sheet P is sent to the sheet clamping and conveying unit and a control unit to control heating temperature of the heating unit in accordance with the image information acquired by the image information acquiring device. With such an exemplary configuration, moisture content of the recording sheet P can be likely preferably adjusted within a prescribed level capable of effectively avoiding occurrence of toner blisters and defective transference as well regardless of the amount of toner borne on the recording sheet P even after the dehumidification of the recording sheet P as described, for example, in the sixth embodiment.

According to yet another aspect of the present invention, the exemplary image forming apparatus is characterized by including a sheet type information acquiring device (for example, an operation display unit or the like) to acquire sheet type information of the recording sheet P before the recording sheet P is sent to the sheet clamping and conveying unit, a contact width changing unit (for example, an eccentric cam 83 or the like) to change a width of an contact area in a rotating direction of the first and second rotary members formed between the first and second rotary members, and a control unit to control the contact width changing device to change the width of the contact area in accordance with the sheet type information acquired by the sheet type information acquiring device. With such an exemplary configuration, by appropriately heating the recording sheet P having the excellent breathability with a prescribed calorific value without changing the heating temperature of the first rotary member, toner blister and defective transference as well can be likely avoided as described, for example, in the seventh embodiment.

According to yet another aspect of the present invention, the exemplary image forming apparatus is characterized by including an environment condition detector to detect one of natural conditions of surroundings of the image forming apparatus, a contact width changing device to change a width of an contact area in a rotating direction of the first and second rotary members formed between the first and second rotary members, and a control unit to control the contact width changing device to change the width of the contact area in accordance with the one of natural conditions of surroundings of the image forming apparatus detected by the environment condition detector. With such an exemplary configuration, moisture content of the recording sheet P can be likely constant even after the dehumidification of the recording sheet P regardless of humidity as described, for example, in the eighth embodiment.

According to yet another aspect of the present invention, the exemplary image forming apparatus is characterized by including a moisture content detector to detect moisture content of a recording sheet P before the recording sheet P is sent to the sheet clamping and conveying unit, a contact width changing device to change a width of an contact area in a rotating direction of the first and second rotary members formed between the first and second rotary members, and a control unit to control the contact width changing device to change the width of the contact area in accordance with the moisture content detected by the moisture content quantity detector. With such an exemplary configuration, by appropriately heating the recording sheet P with a prescribed calorific value in accordance with the moisture content of the recording sheet P without changing the heating temperature of the first rotary member, toner blisters and defective transference as well can be likely avoided as described, for example, in the ninth embodiment.

According to yet another aspect of the present invention, the exemplary image forming apparatus is characterized by including an air permeability information acquiring device to acquire air permeability information of the recording sheet P before the recording sheet P is sent to the sheet clamping and conveying unit, a contact width changing device to change a width of an contact area in a rotating direction of the first and second rotary members formed between the first and second rotary members, and a control unit to control the contact width changing device to change the width of the contact area in accordance with the air permeability information acquired by the air permeability information acquiring device. With such an exemplary configuration, toner blisters and defective transference as well caused due to excessive heating of the recording sheet P having excellent breathability at a high temperature in the sheet clamping and conveying unit can be likely avoided without changing the heating temperature of the first rotary member as described, for example, in the eleventh embodiment.

According to yet another aspect of the present invention, the exemplary image forming apparatus is characterized by including an image information acquiring device to acquire image information to be printed by the image forming unit onto the recording sheet as a toner image in accordance with the image information, before the recording sheet P is sent to the sheet clamping and conveying unit, a contact width changing device to change a width of an contact area in a rotating direction of the first and second rotary members formed between the first and second rotary members, and a control unit to control the contact width changing device to change the width of the contact area in accordance with image information acquired by the image information acquiring device to be printed as a toner image. With such an exemplary configuration, the recording sheet P can be likely preferably heated with a prescribed amount of heat calorie in accordance with the amount of toner without changing the heating temperature of the first rotary member as described, for example, in the twelfth embodiment.

According to yet another aspect of the present invention, the exemplary image forming apparatus is characterized by disposing the moisture content detector at a position to detect moisture content of one side of the recording sheet P not yet bearing a toner image to be printed by the image forming unit. With such an exemplary configuration, by preventing a toner image from intervening between the moisture content detector and the surface of the recording sheet P, an error in detecting the moisture content due to intervening of the toner image can be likely avoided as described, for example, in the fourth embodiment.

Further, according to one embodiment of the present invention, the sheet clamping and conveying unit presses the recording sheet against the first and second rotary members heated by a heating unit within an contact area formed between the first and second rotary members and acts as a dehumidifier to heat and dehumidify the recording sheet before sending the recoding sheet P to an image forming unit. With such an exemplary configuration, disturbance of the toner image, possibly caused by both of the scratches on the contacting target and the toner blisters as well can be likely minimized while more effectively downsizing the image forming apparatus than a conventional printing system in which the dehumidifier is separately disposed from the sheet clamping and conveying unit.

Numerous additional modifications and variations of the present invention are possible in light of the above teachings. It is therefore to be understood that within the scope of the appended claims, the present invention may be executed otherwise than as specifically described herein. For example, the order of steps for forming the image forming apparatus is not limited to the above-described various embodiments and can be likely appropriately changed.

What is claimed is:

1. A sheet clamping and conveying unit to be installed in an image forming apparatus together with an image forming unit to print a toner image onto a recording sheet and a fixing unit to heat and fix the toner image printed by the image forming unit onto the recording sheet, the sheet clamping and conveying unit disposed upstream of the image forming unit and the fixing unit, the sheet clamping and conveying unit comprising:
a housing housed in the image forming apparatus;
a first rotary member having a surface made of metal supported by the housing;
a second rotary member supported by the housing to press against the first rotary member while forming a contact area between the first and second rotary members; and
a heating unit to heat one of the first and the second rotary members,
wherein the sheet clamping and conveying unit conveys a recording sheet toward the image forming unit by clamping, pressing, and heating the recording sheet in the contact area while continuously rotating the first and second rotary members.

2. The sheet clamping and conveying unit as claimed in claim 1, further comprising a pressure adjusting unit operatively connected to one of the first and second rotary members to adjust pressure on the one of the first and second rotary members from the other one of the first and second rotary members.

3. The sheet clamping and conveying unit as claimed in claim 1, wherein the heating unit is a halogen heater.

4. An image forming apparatus comprising:
an image forming unit to print a toner image onto a recording sheet;
a fixing unit to heat and fix the toner image printed by the image forming unit onto the recording sheet; and
a conveying unit disposed upstream of the image forming unit to convey the recording sheet to the image forming unit, the sheet clamping and conveying unit including:
a housing housed in the image forming apparatus;
a first rotary member having a surface made of metal supported by the housing;
a second rotary member supported by the housing to press against the first rotary member while forming an contact area between the first and second rotary members; and
a heating unit to heat one of the first and the second rotary members,
wherein the sheet clamping and conveying unit conveys a recording sheet toward the image forming unit by clamping, pressing, and heating the recording sheet in the contact area while continuously rotating the first and second rotary members.

5. The image forming apparatus as claimed in claim 4, further comprising:
a sheet type information acquiring device to acquire sheet type information of the recording sheet before the recording sheet is sent to the sheet clamping and conveying unit; and
a control unit to control heating temperature of the heating unit in accordance with the sheet type information acquired by the sheet type information acquiring device.

6. The image forming apparatus as claimed in claim 4, further comprising:
a sheet thickness information acquiring device to acquire sheet thickness information of the recording sheet before the recording sheet is sent to the sheet clamping and conveying unit; and
a control unit to control heating temperature of the heating unit in accordance with thickness information of the recording sheet acquired by the sheet thickness information acquiring device.

7. The image forming apparatus as claimed in claim 4, further comprising:
an environment condition detector to detect one of natural conditions of surroundings of the image forming apparatus; and
a control unit to control heating temperature of the heating unit in accordance with the one of natural conditions of surroundings of the image forming apparatus detected by the environment condition detector.

8. The image forming apparatus as claimed in claim 4, further comprising:
a moisture content detector to detect moisture content of a recording sheet before the recording sheet is sent to the sheet clamping and conveying unit; and
a control unit to control heating temperature of the heating unit in accordance with the moisture content detected by the moisture content detector.

9. The image forming apparatus as claimed in claim 4, further comprising:
an air permeability information acquiring device to acquire air permeability information of the recording sheet before the recording sheet is sent to the sheet clamping and conveying unit; and
a control unit to control heating temperature of the heating unit in accordance with the air permeability information acquired by the air permeability information acquiring device.

10. The image forming apparatus as claimed in claim 4, further comprising:
an image information acquiring device to acquire image information to be printed by the image forming unit onto the recording sheet as a toner image in accordance with the image information, before the recording sheet is sent to the sheet clamping and conveying unit; and
a control unit to control heating temperature of the heating unit in accordance with the image information acquired by the image information acquiring device.

11. The image forming apparatus as claimed in claim 4, further comprising:
a sheet type information acquiring device to acquire sheet type information of the recording sheet before the recording sheet is sent to the sheet clamping and conveying unit;
a contact width changing device to change a width of the contact area in a rotating direction of the first and second rotary members formed between the first and second rotary members; and
a control unit to control the contact width changing device to change the width of the contact area in accordance with the sheet type information acquired by the sheet type information acquiring device.

12. The image forming apparatus as claimed in claim 4, further comprising:
an environment condition detector to detect one of natural conditions of surroundings of the image forming apparatus;
a contact width changing device to change a width of an contact area in a rotating direction of the first and second rotary members formed between the first and second rotary members; and
a control unit to control the contact width changing device to change the width of the contact area in accordance with the one of natural conditions of surroundings of the image forming apparatus detected by the environment condition detector.

13. The image forming apparatus as claimed in claim 4, further comprising:
a moisture content detector to detect moisture content of a recording sheet before the recording sheet is sent to the sheet clamping and conveying unit;
a contact width changing device to change a width of an contact area in a rotating direction of the first and second rotary members formed between the first and second rotary members; and
a control unit to control the contact width changing device to change the width of the contact area in accordance with the moisture content detected by the moisture content quantity detector.

14. The image forming apparatus as claimed in claim 4, further comprising:
an air permeability information acquiring device to acquire air permeability information of the recording sheet before the recording sheet is sent to the sheet clamping and conveying unit;
a contact width changing device to change a width of an contact area in a rotating direction of the first and second rotary members formed between the first and second rotary members; and
a control unit to control the contact width changing device to change the width of the contact area in accordance with the air permeability information acquired by the air permeability information acquiring device.

15. The image forming apparatus as claimed in claim 4, further comprising:
an image information acquiring device to acquire image information to be printed by the image forming unit onto the recording sheet as a toner image in accordance with the image information, before the recording sheet is sent to the sheet clamping and conveying unit;
a contact width changing device to change a width of an contact area in a rotating direction of the first and second rotary members formed between the first and second rotary members; and
a control unit to control the contact width changing device to change the width of the contact area in accordance with image information for recording the toner image acquired by the image information acquiring device.

16. The image forming apparatus as claimed in claim 8, wherein the moisture content detector is disposed at a position to detect moisture content of one side of the recording sheet not yet bearing a toner image to be printed by the image forming unit.

17. A method of forming an image comprising the steps of:
feeding a recording sheet downstream from a sheet feeding tray;
clamping the recording sheet with a sheet clamping and conveying unit including a first rotary member having a metal surface and a second rotary member pressing against the first rotary member while forming a contact area between the first and second rotary members;
heating one of the first and the second rotary members of the sheet clamping and conveying unit with a heating unit when the sheet clamping and conveying unit clamps the recording sheet;
conveying the recording sheet downstream toward an image forming unit with the sheet clamping and conveying unit by continuously rotating the first and second rotary members while clamping, pressing, and heating the recording sheet between the first and second rotary members;
printing a toner image with an image forming unit onto the recording sheet; and
heating and fixing the toner image formed onto the recording sheet with a fixing unit; and
ejecting the recording sheet outside a machine.

18. The method as claimed in claim 17, further comprising the steps of:
acquiring one of sheet type information of the recording sheet with a sheet type information acquiring device, sheet thickness information of the recording sheet with a sheet thickness information acquiring device, one of natural conditions of surroundings of the image forming apparatus with an environment condition detector, moisture content of the recording sheet with a moisture content detector, air permeability information of the recording sheet with an air permeability information acquiring device, and image information to be printed by the image forming unit as a toner image onto the recording sheet with an image information acquiring device before the step of conveying the recording sheet to the sheet clamping and conveying unit; and
controlling heating temperature of the heating unit with a control unit in accordance with one of the sheet type information of the recording sheet, the sheet thickness information of the recording sheet, the one of natural conditions of surroundings of the image forming apparatus, the moisture content of the recording sheet, the air permeability information of the recording sheet, and the image information to be printed, respectively.

19. The method as claimed in claim 17, further comprising the steps of:
acquiring one of sheet type information of the recording sheet with a sheet type information acquiring device, sheet thickness information of the recording sheet with a sheet thickness information acquiring device, one of natural conditions of surroundings of the image forming apparatus with an environment condition detector, moisture content of the recording sheet with a moisture content detector, air permeability information of the recording sheet with an air permeability information acquiring device, and image information to be printed by the image forming unit as a toner image onto the recording sheet with an image information acquiring device before the step of conveying the recording sheet to the sheet clamping and conveying unit; and
changing a width of the contact area in a rotating direction of the first and second rotary members formed between the first and second rotary members with a contact width changing device in accordance with one of the sheet type information of the recording sheet, the sheet thickness information of the recording sheet, the one of natural conditions of surroundings of the image forming apparatus, the moisture content of the recording sheet, the air permeability information of the recording sheet, and the image information to be printed, respectively.

20. The method as claimed in claim 18, wherein the moisture content detector is disposed at a position to detect moisture content of one side of the recording sheet not yet bearing a toner image to be printed by the image forming unit.
